(19) United States
(12) Patent Application Publication
(10) Pub. No.: US 2002/0148335 A1
(43) Pub. Date: Oct. 17, 2002

(54) Guillotine cutter machine for cutting stacked, sheet material

(76) Inventors: Helmut Gross, Hofheim (DE); Adolf Rasch, Wuesbaden (DE)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/174,344

(22) Filed: Jun. 18, 2002

Related U.S. Application Data
(63) Continuation of application No. 09/473,102, filed on Dec. 28, 1999.

(30) Foreign Application Priority Data
Dec. 28, 1998 (EP) 98124487.4

(51) Int. Cl. B26D 7/06

(52) U.S. Cl. 83/91; 83/613

(57) ABSTRACT

A guillotine cutter machine for cutting stacked sheet material includes a table for receiving the material. A rear table part receives the material to be cut, and a front table part receives the cut material. The two table parts can be moved apart in order to form a gap. A first movable guide plate can be disposed in the region of the front table part. A second movable guide plate can be brought into its operating position after the gap has opened so that a transverse channel for the cut material is formed between the two guide plates. The cut material can be fed to a further processing station by an ejector which can move along the transverse channel. So as to be able, using one and the same guillotine cutter machine, not only to make cuts for the production of partial stacks and of small stacks which are produced perpendicularly thereto on cutting, but also to feed the small stacks automatically to further processing operations, the invention may include a mobile alignment station that can be attached to the guillotine cutter machine in the region of the front table part, wherein the mobile alignment station comprises the first guide plate.

### CROSS-REFERENCE TO RELATED APPLICATION

The present application is a continuation of co-pending U.S. patent application Ser. No. 09/437,102, filed Dec. 28, 1999, entitled GUILLOTINE CUTTER MACHINE FOR CUTTING STACKED SHEET METAL, which is hereby incorporated herein by reference.

### DESCRIPTION

This invention relates to a guillotine cutter machine for cutting stacked, sheet material according to the precharacterising clause of claim 1.

A guillotine cutter machine is known from EP-A-0 242 763. Together with a further guillotine cutter machine, this forms an arrangement which makes it possible to subdivide a large initial stack into small stacks. The edge cuts which may be necessary are made on the stack by the first guillotine cutter machine, after which the stack is present as an initial stack, and the initial stack is also separated into partial stacks by this machine. The partial stacks are collected on a support and are fed to the second guillotine cutter machine, which is constructed according to the precharacterising clause of claim 1, wherein said second guillotine cutter machine is disposed perpendicularly to the first-mentioned guillotine cutter machine. In the second cutter machine, the partial stacks are subdivided, on each cut, into small stacks which are arranged in rows. The first guide plate is disposed in front of the partial stacks with respect to the direction of feed of the material, and is thus disposed in the region of the front table part. The second guide plate can be introduced into the gap formed between the front and rear table parts, adjacent to the rear end of the front table part. The two guide plates form a transverse channel between them which receives the small stacks, which can be fed to a further processing station by means of an ejector.

The further processing station may be an automatic bundling device or a label punch, for example. The aim and purpose of the arrangement described above is to be able to carry out the cutting process in what is a substantially completely automated manner. Since the edge trimming and cutting of the initial stack in the first direction are effected by means of the first guillotine cutter machine, the function of the second guillotine cutter machine is simply to separate the material to be cut in the second direction. For this purpose, it is not necessary to manipulate the material to be cut in the region of the front table part. It is merely necessary to provide suitable means so that the partial stacks produced on each cut can be transported away accurately to the side. In order to achieve this, the first guide plate, which is permanently associated with the initial area, is disposed on the initial area. The first guide plate is provided with drive means which make it possible to move the guide plate by a limited extent of travel in the opposite direction to the direction of feed, in order to press the material to be cut against the feeder device. Moreover, drive means are provided for tilting the first guide plate about a lower horizontal axis, so that the partial stacks are supported when the small stacks are produced and can subsequently be aligned vertically again.

A guillotine cutter machine for cutting stacked sheet material is known from WO 91/00168 A, although the construction of this machine is complicated. The front table part of the machine is of two-part construction, wherein the front section of the table part is raised after separating the initial stack into partial stacks, so as thus to be able to bring a first movable guide plate, which is disposed underneath the front section of the front table part, into position in order to form small stacks in connection with the further separation of the partial stacks. Whereas the rear section of the front table part is fixedly mounted in a base frame which can move horizontally, the front section of the front table part is mounted in a vertically movable intermediate frame, which is mounted in the base frame and which, underneath the front section of the front table part, receives the first guide plate and elements for horizontally moving and swiveling said guide plate. The first guide plate thus forms a fixedly installed component of the front table construction.

EP-A-0 453 933 describes a guillotine cutter machine for cutting small narrow stacks of sheet material. This guillotine cutter machine can only produce stacks of constant dimensions as seen in the direction of feed of the material. An L-shaped element for receiving the cut small stacks is provided for this purpose. The lower arm of the L-shaped element fits under the small stacks, whilst the other arm serves as a lateral support for the stacks. The L-shaped element is mounted so that it can be moved and swiveled horizontally in a front table part of the guillotine cutter machine, which front table part does not serve to receive the cut material, however. The purpose of this type of mounting of the L-shaped element is to enable the L-shaped element to be tilted away when separating the partial stack by means of the wedge-shaped cutter and thus when forming small stacks which are at first displaced into the shape of a parallelogram, whilst the front edge of the L-shaped element remains in a plane with the table surface.

A guillotine cutter machine for cutting stacked, sheet material is known from EP-A-0 056 874 which comprises a table for receiving the material, wherein a rear table part serves to receive the material to be cut and a front table part serves to receive the cut material. This guillotine cutter machine has a guide plate underneath the table in the region of the interface between the front and rear table parts. When a gap is formed between the two table parts this guide plate is moved towards the rear edge of the front table part, so that the stack or stacks of cut material which was or were cut last, and which as a result of the arrangement of the cutting strip of the guillotine cutter machine protrude slightly beyond the rear edge of the front table part, can be pushed completely on to the latter. In addition, in this the guide plate serves as a protection from swarf when an intermediate cut is made, wherein the cutting waste is disposed of downwards through the gap. A guillotine cutter machine such as this does not enable the process to proceed automatically with respect to the cut for producing small stacks and the transfer thereof to a further processing station.

### SUMMARY OF THE INVENTION

The object of the present invention is further to develop a guillotine cutter machine according to the precharacterising clause of claim 1 so as to be able, using one and the same guillotine cutter machine which is of particularly simple construction, not only to make cuts for the production of partial stacks and of small stacks, but also to feed the small stacks automatically to further processing operations.

This object is achieved by a guillotine cutter machine having the features of claim 1.

An essential feature of the present invention is that it is only when the front table part is required for operating procedures that the mobile alignment station, which is thus not attached to a fixed location of the front table part, is used in order to be able reliably to cut the small stacks and to transport them away, particularly to further processing stations. The mobile alignment station is thus a component which has to be installed each time. The invention is based on the fundamental concept of providing a guillotine cutter machine which can be operated manually but which nevertheless enables operating sequences during cutting, which were hitherto hazardous as manual activities, to be performed automatically by means of particularly simple retooling operations. Thus, when the mobile alignment station which receives the first guide plate is not associated with the front table part, operations can be performed manually over the entire region of the table, and can thus be performed in the region of the rear and the front table parts. This is particularly advantageous for edge trimming, when the stack of material to be cut is of large size and has to be manipulated by the person operating the guillotine cutter machine, particularly in the region of the front table part, in order to turn the material. Thus, after an edge cut has been made, the operator pulls the stack of cut material forwards, i.e. into the region of the front table part, turns it by 90° or 180°, and pushes it back on to the rear table part towards the feeder device, which advances the stack of the material to be cut by the exact distance of the cut. The mobile alignment station is not used until the initial stack which is present after the edge cuts has been subdivided into partial stacks in one direction and these have been turned by 90° in order subsequently to separate them into small stacks. The mobile alignment station is attached to the apparatus in the region of the front table part, so that the first guide plate can take over the function of aligning and supporting the partial stacks or small stacks during the cut. The cut small stacks are transported away through the transverse channel formed between the two guide plates. This is preferably effected by means of an ejector.

In principle, the mobile alignment station can be attached to the guillotine cutter machine at any suitable location of the guillotine cutter machine in the region of the front table part. Thus, for example, it can even be attached to the gantry frame of the guillotine cutter machine which extends above the table and which at the same time serves to receive the cutting knife and the press crosshead. According to one particular embodiment of the invention, however, the mobile alignment station can be attached to the front table part. The advantage achieved here is that it is possible to effect the exact positioning of the mobile alignment station in a simple manner by means of the front table part and an attachment can be made in a particularly simple manner between the mobile alignment station and the front table part. Apart from this, the mobile alignment station can be mounted in an uncomplicated manner on the front table part. In this respect, it is considered to be advantageous if a side table part, which serves to receive the mobile alignment station when the latter is not in use, is disposed beside the front table part. If the surfaces of the front and side table parts form a plane, the mobile alignment station can be moved to and fro without difficulty between the two table parts. This high degree of mobility of the alignment station is a fundamental requirement of the guillotine cutter machine according to the invention, since during the cutting cycles to be performed the alignment station is either used or is not used, and in the latter situation the region of the front table has to be freed from the mobile alignment station.

According to one preferred embodiment, the side table can be raised and lowered and comprises two table planes disposed one above the other, wherein the lower table plane serves to receive the mobile alignment station when the latter is not in use, wherein in addition the upper table plane forms a plane with the surface of the front table part when the side table part is lowered and the lower table plane forms a plane with the surface of the front table part when the side table part is raised. This design of the side table enables the mobile alignment station, when not in use, to be positioned underneath the working plane of the side table part. Particularly when cutting the initial stack in the first direction of cutting in order to form partial stacks, the working face of the side table part is available to the person operating the guillotine cutter machine for the placement or interim storage of the partial stacks and is not occupied by the mobile alignment station, which is not required during this sequence of operations. When the mobile alignment station is used, the side table part, together with the mobile alignment station resting on the lower table plane thereof, is raised, and with the side table part in its raised position the mobile alignment station is displaced or moved on to the front table part. If the working face of the side table part is required during subsequent operating procedures, the side table part is lowered again, so that the upper table plane thereof is again aligned with the table plane of the front table part.

So as to be able to move the mobile alignment station particularly easily, it should have wheels or rollers on its underside.

It should be ensured that in its operating position the mobile alignment station assumes a defined position in relation to the front table part and that parallelism to the cutting plane of the cutting knife is ensured, particularly with the first guide plate in its vertical position, and is also maintained during the relevant operating procedures. A secure arrangement of the mobile alignment station on the front table part can be ensured, for example, by providing the mobile alignment station on its underside and/or at its sides with elements which act by means of reduced pressure or which act magnetically and which can be brought into active communication with the front table part and/or with a lateral stop disposed in the region of the front table part. Alternatively, or in addition thereto, it is possible to attach the mobile alignment station positively to the front table part and/or to a lateral stop disposed in the region of the front table part. A positive attachment should be understood to be one which prevents the mobile alignment station from being able to move in the table plane of the front table part. According to one specific design, the mobile alignment station is provided with positioning elements which can be brought into active communication with complementary positioning elements of the front table part. It is considered to be particularly advantageous if the positioning elements of the mobile alignment station are constructed as centering pins and the complementary positioning elements of the front table part are constructed as centering receivers. These cooperating centering pins and centering receivers enable the receiving position of the mobile alignment station in the front table part to be altered to the effect that absolute parallelism is ensured between the vertically disposed first guide plate and the cutting plane. Provision is made in particular for a plurality of pairs of complementary positioning elements to be disposed in the front table part at different vertical spacings from the cutting plane of the cutting knife. This construction of the guillotine cutter machine is particularly advantageous if what are termed mixed production cuts are to be made with the machine. This means that under some circumstance, after cutting small stacks with an extent which is slight in the direction of feed, small stacks have to be cut, the extent of which in the direction of feed is greater. These operations can be put into effect simply by displacing the mobile alignment station perpendicularly to the cutting plane. If the mobile alignment station could not be displaced on the front table part, the result of cutting in mixed operation would be that considerable distances of travel would have to be covered by first guide plate. Instead of this, in the advantageous embodiment described above the guide plate only has to be designed for short distances of travel, which is also advantageous as regards the precise alignment of the guide plate with respect to the components of the mobile alignment station which receive it and as regards its alignment with respect to the front table part.

It is considered to be advantageous if the feeder device and/or the first guide plate are provided with movable lateral contact placement devices. This enables the turned partial stack to be fixed between one or more movable contact placement devices and a fixed lateral contact placement device of the rear table part. This is generally effected before or during the cut in the second direction and is particularly advantageous when narrow sheets have to be cut. It is thereby ensured that the narrow sheets are aligned exactly parallel to each other, and that the partial stack which is associated with the fixed lateral contact placement device lies flat thereon. Moreover, the lateral contact placement device of the feeder device should be displaceable in the direction of feed and in the opposite direction. The lateral contact placement device of the feeder device can thereby be moved out of the front region of the feeder device, which is generally constructed as a grid. The feeder device can thus be advanced by a considerable extent, so that the feeder grid meshes with a grid section, which faces it, of the press crosshead of the guillotine cutter machine.

When small stacks are cut from the partial stacks, or during an intermediate cut, particularly in combination with the disposal of cutting waste through the gap, the first guide plate has to execute diverse movements, and in particular has to effect movements of the material to be cut. Thus the guide plate can be moved by an extent of advance in order to produce the small stacks, by an extent of advance in order to compensate for the swiveling movement of the guide plate, and by an extent of advance corresponding to the intermediate cut.

In one preferred embodiment of the invention, in order to implement the courses of movement of the first guide plate in a particularly simple manner, the mobile alignment station is provided on its upper surface with units for movably receiving the first guide plate. At the same time, the first guide plate can advantageously swivel about a horizontal pivot, which thus runs parallel to the table plane of the front table part. It is considered to be advantageous with regard to its construction if the mobile alignment station comprises a base element, particularly a base element in the form of a sheet in which the first guide plate is mounted so that it can travel and swivel. For example, the base element can receive a bearing element which can be moved by means of at least one actuating element, and in addition the first guide plate, which can be swiveled by means of at least one further actuating element, is mounted in the bearing element. The rectilinear travelling movement and the swiveling movement of the guide plate are thus kinematically separated, and are consequently generated by means of different actuating elements. It is considered to be advantageous if the guide plate can swivel in the region of its lower end about a pivot on the bearing element side, and if the upper end of the guide plate is mounted in the bearing element via a toggle lever, wherein the further actuating element acts on the toggle lever and on the bearing element. Furthermore, pneumatic and/or electrical control means should be provided for operating the actuating elements for the first guide plate and/or for operating the elements for the attachment of the mobile alignment station to the front table part. These electrical control means can be wire-free operating means, and infrared-based control means can be provided in particular.

The aforementioned measures enable the first guide plate, since the latter is a mobile component which has to be installed, to be positioned in a defined manner with respect to the front table part or with respect to the partial stacks to be cut, and enable the sequences of movement which are to be executed by the first guide plate to be ensured. Thus, for example, when it is installed the guide plate can be positioned against the partial stacks to be cut. In particular, if when the first guide plate is installed it is positioned against the partial stacks which are disposed with their front faces in the cutting plane, it is ensured that the guide plate is associated with a defined, fixedly predetermined plane, namely the cutting plane of the cutter. The coordinates of movement of the first guide plate can thus be fixed with respect to the cutting plane. On the other hand, it is possible to effect a variable correspondence of the contact face of the first guide plate in relation to the cutting plane. This means that the plane of contact of the first guide plate is positioned at an arbitrary spacing from the cutting plane, and the position of the guide plate, particularly its position in relation to the cutting plane, is determined by means of electronics. In particular, the electronics determine how far the vertically positioned plane of contact of the guide plate is from the cutting plane, and takes this into account during the current cutting process. It is known from the prior art that the positions of machine parts, for example the position of the feed cradle of the cutting machine with respect to the cutting plane, can be determined and represented by means of electronics. If the mobile alignment station is attached to the front table part via the positioning elements, the position of the alignment station with respect to the table part follows directly and can be evaluated via the electronics unit. In particular, the actuating elements for the first guide plate can be positioned depending on the respective cutting sequence by means of the control means, particularly the electronics. The electronics preferably detect the descending movement of the cutting knife and control the actuator for swiveling the first guide plate corresponding to the passage of the wedge-shaped cutting knife through the stack to be cut. Superimposed thereon, or subsequently thereto, there is a slight horizontal movement of the first guide plate away from the cutting plane, in order to effect the complete movement of the small stacks, which have been displaced into the form of a parallelogram, on to the front table part when the second guide plate, which is aligned vertically, is completely seated against the rear edge of the front table part. When the second guide plate is disposed vertically, the first guide plate tilts into its vertical position.

Other features of the guillotine cutter machine according to the invention are presented in the description of the Figures, in the Figures and in the subsidiary claims, whereupon it should be remarked that all individual features and all combinations of individual features constitute the essence of the invention.

### DESCRIPTION OF THE DRAWINGS

The invention is illustrated in the Figures by way of a plurality of embodiments of a guillotine cutter machine, without being limited thereto. The Figures are as follows:

FIG. 1 is a plan view of a first embodiment of the guillotine cutter machine, with a mobile alignment station, which is situated in its out-of-use position, placed on a side table, and with a stack of cut material resting on the rear table part before the edge trimming operation;

FIG. 2 is an illustration corresponding to that of FIG. 1, showing the stack of cut material resting on the rear table part after the edge trimming operation, and thus showing the initial stack resting on the rear table part before partial stacks are cut in a first direction;

FIG. 3 is a view corresponding to that of FIG. 2, showing the partial stacks resting on the rear table part and turned by 90°, before they are cut in the second direction;

FIG. 4 shows the guillotine cutter machine of FIG. 3 with the mobile alignment station, against the guide plate of which the advanced partial stacks are seated, placed on the front table part in a position for making the first cut in the second direction for the purpose of separating the diverse small stacks;

FIG. 5 shows a cut being made by the cutting machine along line V-V of FIG. 4;

FIGS. 6 to 8 show the mobile alignment station which is circled in FIG. 5 resting on the front table part in various operating positions;

FIG. 9 is a view in direction IX of the mobile alignment station shown in FIG. 8;

FIGS. 10 to 15 illustrate processing steps which demonstrate the mode of operation of the guillotine cutter machine without intermediate cuts between the individual main cuts;

FIGS. 16 to 19 illustrate processing steps which are inserted when making an intermediate cut between the main cutting operations;

FIG. 20 shows a modified form of the guillotine cutter machine with lateral contact placement devices on the feeder device and on the first guide plate, as a view corresponding to that of FIG. 4;

FIG. 21 is a detailed view of the lateral contact placement devices of the feeder device, as seen in the direction of arrow D in FIG. 20;

FIG. 22 is a view of the feeder device and of the lateral contact placement devices associated therewith, as seen in the direction of arrow E in FIG. 21;

FIG. 23 shows a modified form of the device for fixing the mobile alignment station to the front table part, as a view corresponding to that of FIG. 10;

FIG. 24 shows a modified form of the mobile alignment station with lateral contact placement devices and centering pins, as a view according to that of FIG. 9;

FIG. 25 is a section, on an enlarged scale, through the device for centering the mobile alignment station and the front table part; and

FIG. 26 shows a modified form of the additional table part for receiving the mobile alignment station when the latter is not required.

### DETAILED DESCRIPTION OF THE PREFERRED EMBODIMENTS

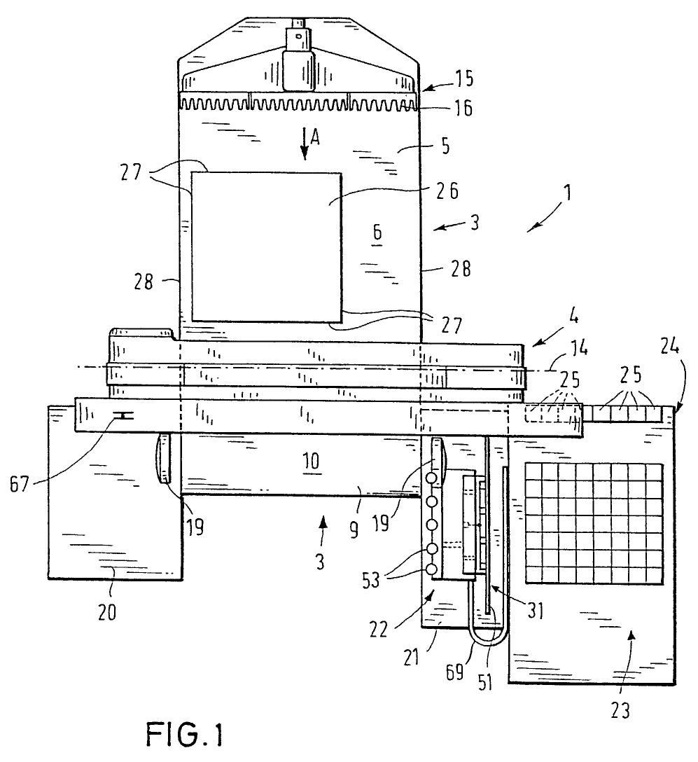

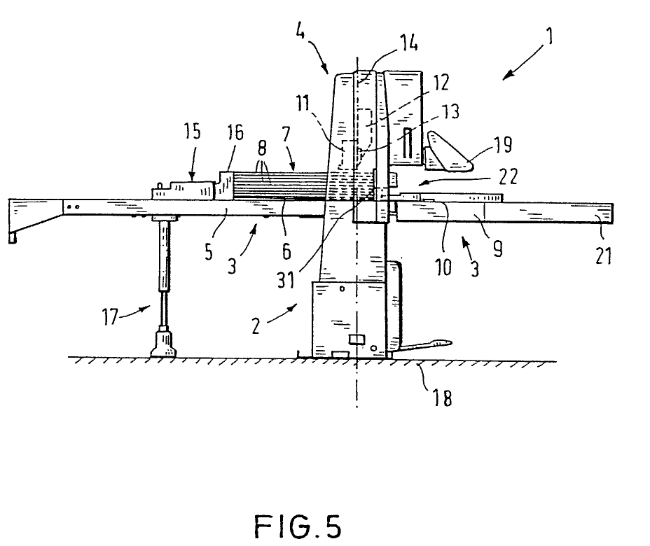

The basic design of the guillotine cutter machine can be seen from the illustrations of FIGS. 1 and 5. The guillotine cutter machine 1 comprises a stand 2, a table 3 supported by the stand and a gantry frame 4 which extends above the table 3. A rear table part 5 with table surface 6 serves to receive the material to be cut 7, which consists of stacked sheet material. The individual layers of sheets are denoted by reference numeral 8. A front table part 9 serves to receive the cut material in the region of its table surface 10. A press crosshead 11, which is placed above the rear table part 5 and can be lowered on to the material to be cut 7, is mounted in the gantry frame 4. A cutter support 12 is movably mounted in front of the press crosshead 11 in the gantry frame 4. A cutting knife 13 is screwed to the cutter support in the region of the lower end thereof. The lower ends of the cutting knife 13 and of the cutter support 12 are of wedge-shaped construction, wherein the face of the cutting knife 13 which faces the press crosshead 11 is positioned perpendicularly to the table surfaces 6 and 10 and the cutting plane 14 is thereby formed. A cutting strip, which is not shown, is embedded in the rear table part 5 below the cutting knife 13, at a short distance from the interface between the rear table part 5 and the front table part 9. In its bottom dead center position, the cutting knife 13 slightly penetrates the cutting strip, in order to ensure that even the lowermost layer of the stack of sheet material, which consists of paper, cardboard, foil or the like, is completely severed. The cutting knife is guided in the known manner in a swinging cut. In the region of the rear table part, a feed cradle 15 is mounted in the rear table part 5 so that it can move in the direction of feed A (FIG. 1) of the material 7 to be cut. The feed part 16 of the feed cradle, which comes into contact with the material 7 to be cut, is of comb-like construction at the front, and has a height which is greater than that of the maximum height of insertion of the material 7 to be cut. The drive for moving the feed cradle 15 in the direction of feed and in the opposite direction thereto is not illustrated. A plurality of pillars 17, which support the rear table part towards the floor 18, is disposed under the loaded rear table part 5.

The operating region of the person operating the guillotine cutter machine 1, who is situated in front of the front table part 9, is protected by photoelectric barriers 19 disposed on the gantry frame 4 at the side of the front table part 9. At the side of the front table part 9 there are placement tables 20 and 21, on which cut material or material to be cut can optionally be temporarily stored. The placement table 21 to the right of the operator also serves to receive a mobile alignment station 22 when the latter is not required. A further processing station 23, which can be a label punch or an automatic bundling device for example, is positioned at the side of the placement table 21. The small stacks which are cut by means of the guillotine cutter machine are fed in rows to the further processing station 23, as shown in FIG. 1. Before the last row of small stacks was fed, seven further rows had already been fed to the further processing station 23.

The procedure for forming the row of small stacks is described below, wherein a row of this type is denoted in FIG. 1 by reference numeral 24, and the respective small stacks are denoted by reference numeral 25. In the specific case illustrated, eight rows of stacks 24, each comprising eight small stacks, are cut from each initial stack.

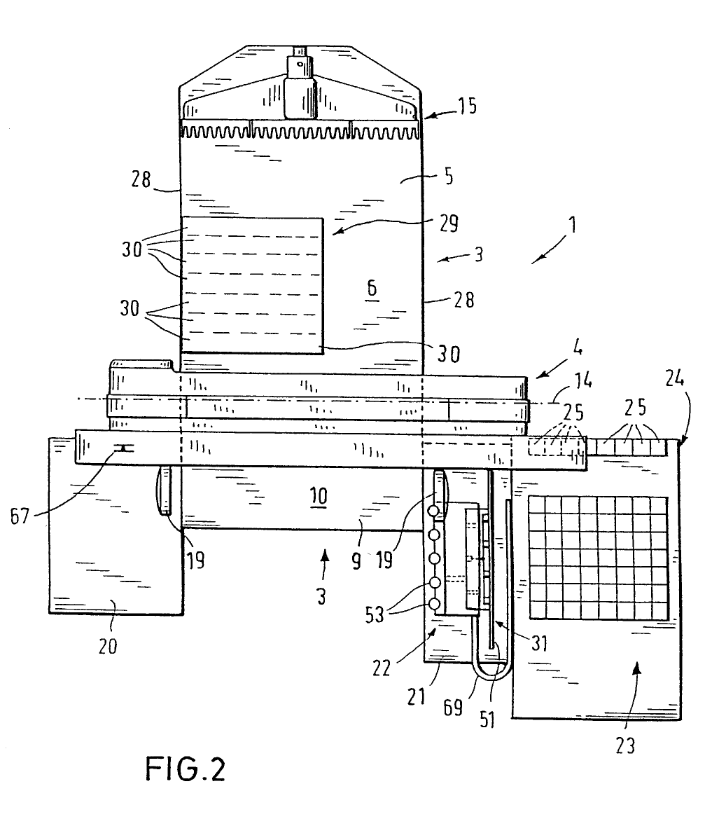

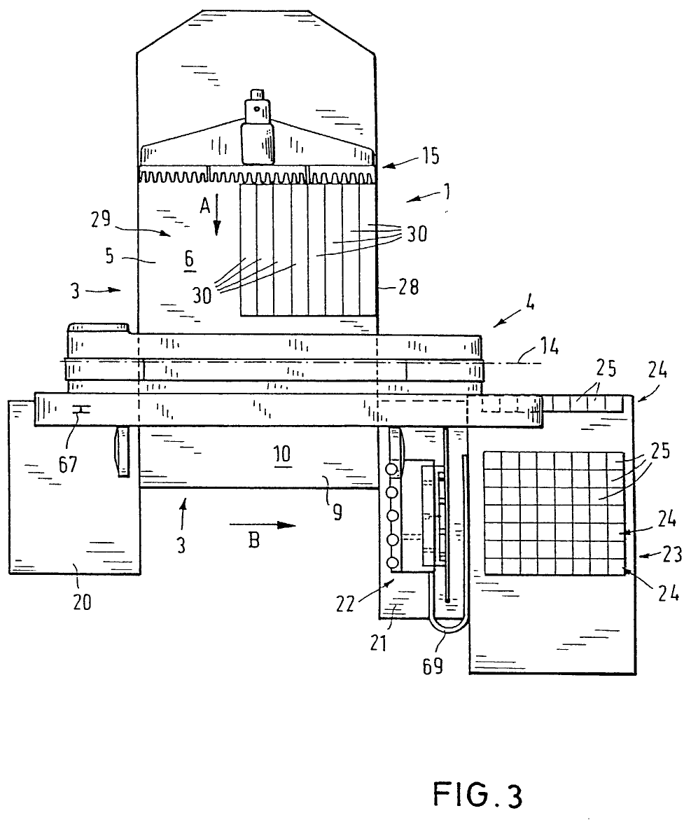

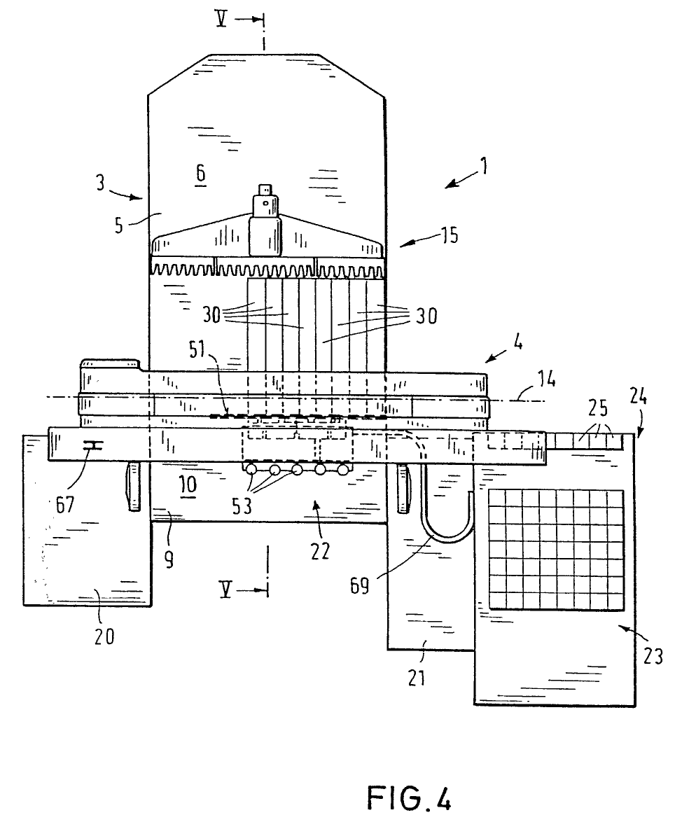

FIG. 1 shows the mobile alignment station 22 resting on the side placement table 21, where both the rear table part 5 and the front table part 9 of the guillotine cutter machine 1 are free for working with the machine. The large stack of sheet material 26 is first trimmed at its four edges 27, by placing it each time against the lateral contact placement device 28 of the rear table part 5 and advancing it into the cutting position by means of the feed cradle 15. After each cut, the feed cradle 15 moves back, and the operator can pull the stack 26 forward slightly and can turn it by 90° on the front table part 9 or underneath the gantry frame 4. In order to make the next edge cut, the stack 26 is placed against the lateral contact placement device 28 and the feed cradle 15. After the four edge cuts, the initial stack 29, the dimensions of which have been reduced, is present as shown in FIG. 2. The cuts to be made on the initial stack are illustrated by the dashed lines in FIG. 2. With the initial stack 29 seated against the lateral contact placement device 28, eight partial stacks 30 are formed by seven cuts in the first direction of the initial stack 29, by successively advancing the feed cradle 15 by the predetermined extent. FIG. 3 shows these eight partial stacks 30, which are disposed side by side but which are positioned turned by 90°, in a position in which their end faces are seated against the feed cradle and in which, in the region of a partial stack 30, they are seated against the right-hand lateral contact placement device 28. Starting from here, the guillotine cutter machine is operated so that after advancing the initial stack 29 which thus exists, a cut is made in each case in order to form the eight small stacks 28 which are thereby produced, and after the front table part 9 has traveled in the direction of the arrow A these small stacks 25 are ejected perpendicularly to the direction of feed A, namely in the direction of the arrow B, towards the further processing station 23. When the small stacks 25 are cut off as shown in the illustration of FIG. 4, the mobile alignment station 22 comes into use, and as soon as the initial stack 29 no longer requires the space of the front table part 23, the mobile alignment station can be moved from the placement table 21 on to the front table part 9 and is positioned there at a defined location.

The mobile alignment station 22 can be attached to the front table part 9 by means of five suction elements 53. FIGS. 1 to 4 show an alignment station 22 which comprises suction elements 53 in a row on its side facing the operator.

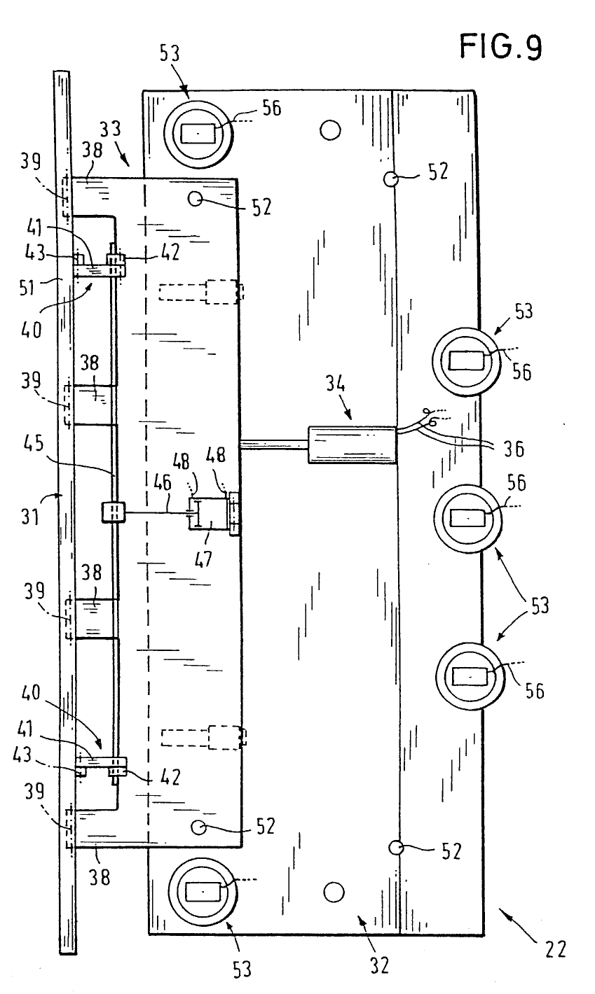

The mobile alignment station 22 shown in FIGS. 8 and 9 can be fixedly attached to the front table part 9 and receives a first guide plate 31 which can travel horizontally and which can swivel about a horizontal pivot. The mobile alignment station 22 has a plate-shaped base element 32. A bearing element 33, which can be moved by means of an electric actuating motor 34, is mounted in the base element. The actuating motor is fixed at one end to the substantially plate-shaped base element 32, and acts on the bearing element 33 by means of a rod 35 which can move in the direction of the double arrows C. Reference numeral 36 denotes electrical connections for the actuating motor 34. The actuating motor can be a servomotor, for example. The plate-shaped base element 32 has two parallel guides 37 for guiding the bearing element 33. The latter is provided with four lower bearing receivers 38 in which the lower region of the guide plate 31 is mounted so that it can swivel about pivots 39. Two swivel-acting toggle levers 40 act on a middle region of the bearing element 33. The arms 41 and 42 of the respective toggle lever 40 exert a swiveling action at the top of the guide plate 31 or on the bearing elements 33, in the region of the pivots 43 and 44. A bearing spindle joins the two toggle levers 40 in the region of the joint between the respective two arms 41 and 42, and a piston rod 46 of a pneumatic cylinder 47 acts on the spindle 45, at about half the length of the spindle 45, wherein the pneumatic cylinder 47 is swivel-mounted in an upper section of the bearing element 43. Reference numerals 48 denote the pneumatic connections of the pneumatic cylinder 47. Since the coupling of the guide plate 31 at the lower coupling point thereof, namely in the region of the pivots 39, is situated above the table surface 10 of the front table part 9, and since it must be permanently ensured that the guide plate contacts the table surface 10 so that it can also act upon the lower layers of sheets of the respective stack, a plate 50 which can be displaced in the direction of the plane of contact of the guide plate 31 is mounted in the actual guide plate body 51, in the lower region of the guide plate 31 on the side thereof which faces the rear table part 5. When the guide plate 49 swivels, the lower edge of the plate 50, which is in contact with the table surface 10, can thus move in relation to the actual guide plate body 51. On its underside, the plate-shaped base element 32 of the mobile alignment station 22 is provided, substantially in the comers of the base element 32, with four running rollers 52, so that the mobile alignment station can be moved from the placement table 21 to the front table part 9 and back without having to be raised. So as to be able permanently to position the mobile alignment station 22, it is provided in a modified embodiment with three suction elements 53 in its rear region and with two further suction elements 53 in its front side regions. These suction elements can be placed on the front table part 9 under the action of reduced pressure. The suction elements 53 can swivel about pivots 55 which are mounted in vertically extending slots 54 in the plate-shaped base element 52. Reference numeral 56 denotes pneumatic connections to the suction elements 53.

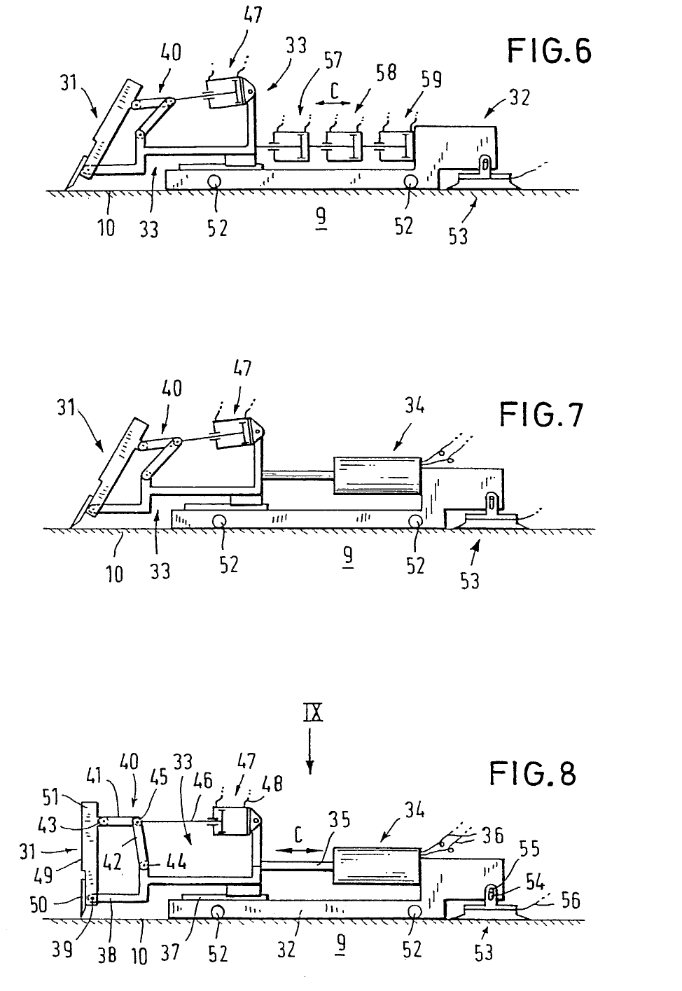

FIG. 8 shows the mobile alignment station 22 with the bearing element 33 moved back and with the piston of the pneumatic cylinder 47 extended, where the guide plate 31 has moved into its vertical position. In contrast, FIG. 7 shows the piston of the pneumatic cylinder 34 in its retracted position, and consequently shows the guide plate 31 in its swiveled position, in which it has swiveled corresponding to the parallelogram shape of the stack of cut material produced during the cut. FIG. 6 shows a form of construction which is modified compared with the forms of construction shown in FIGS. 7 to 9, in which instead of the electric servomotor 34, with which any positions can be produced, three pneumatic cylinders 57, 58 and 59 which are connected in series act between the plate-shaped base element 32 and the bearing element 33, and three different states of advance of the bearing element 33 in the direction of the double arrow C can be obtained by the positions of these three pneumatic cylinders.

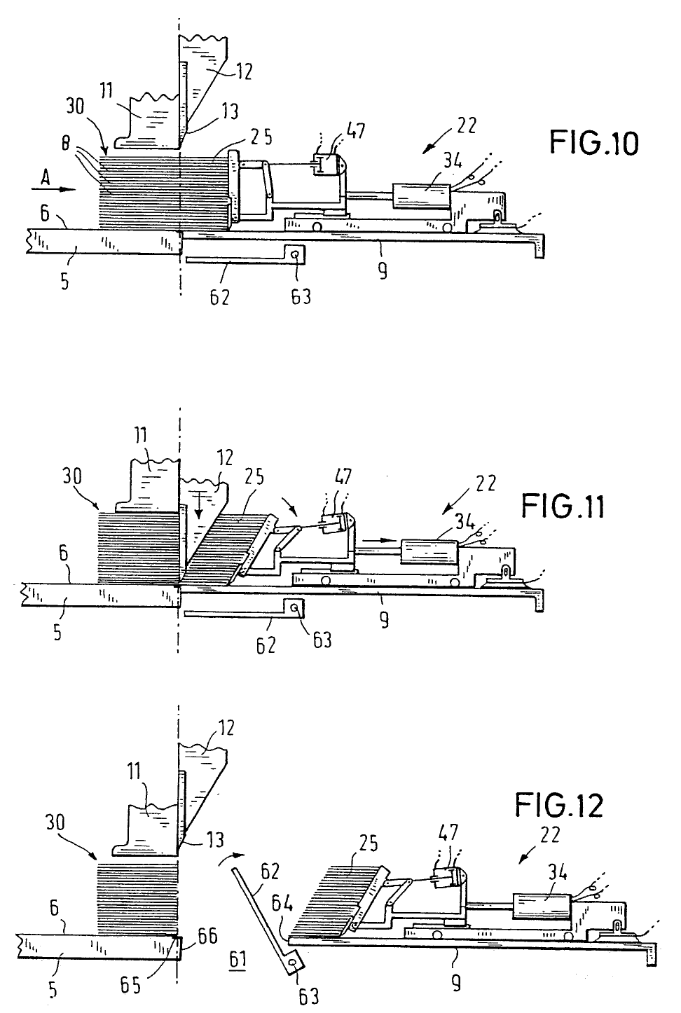

The course of the procedure for cutting the small stacks 25 is described below with reference to the illustrations of FIGS. 10 to 15.

The initial position shown in FIG. 10 constitutes the situation which is reproduced in the general illustration of FIG. 4. The material to be cut, which is present as individual partial stacks 30, is advanced in the direction of feed A by means of the feed cradle 15 as far as the distance of the first cut in order to cut the initial stack in the second direction. The mobile alignment station 22 is then moved from the placement table 21 to the front table part 9 with the guide plate 31 vertical, and is positioned with the guide plate 31 against the front faces of the partial stacks 30 which face it. This position, for example, constitutes the reference position for the subsequent movements of the guide plate 31 and of the bearing element 33. The reference position can be represented in the machine electronics via the position of the feed cradle 15 and the known dimension of the initial stack 29 in the direction of feed A when the initial stack 29 is seated against the feed cradle. In this position of the mobile alignment station 22, the latter is fixedly attached to the front table part 9 by the application of reduced pressure to the suction elements 53. The suction elements 53 are operated by the machine electronics. During the subsequent cut, as shown in FIG. 11, the cutting knife 13 severs the material to be cut and thereby produces the individual small stacks 25, which are displaced into the shape of a parallelogram on account of the wedge-shaped form of the cutting knife 13 and of the cutter support 12. The pneumatic cylinder 47 associated with the toggle levers 40 is actuated via the machine electronics, said actuation being matched to the lowering movement and thus to the cutting movement of the cutting knife 13, so that the guide plate 31 swivels in the direction of the arrow, whereupon at the same time the bearing element 33 is moved away slightly from the cutting plane, since the swivel pin 39 of the guide plate 31 is positioned at a distance from the table surface 30 of the front table part 9, and due to the invariable contact area of the respective small stack 25 the movement of the plate 50 of the guide plate 31 has to be compensated for by taking into account the displacement of thereof.

The front table part 9 is movable and can be moved from the rear table part 5 with the formation of a gap 61. A second guide plate 62 is swivel-mounted about a pivot 63 underneath the front table part 9. When the gap 61 is fully open, this guide plate, which is controlled by the machine electronics, can be swiveled via control means which are not illustrated, for example a pneumatic cylinder, towards the rear edge 64 of the front table part 9, where it is positioned vertically in relation to the table surface 10 and extends over the entire width of the front table part 9, just as the guide plate 31 does. Since for reasons of static loading the cutting strip 65 shown in FIGS. 10 to 15 is set back slightly in relation to the front edge of the rear table part 5, after the cut shown in FIG. 11 the respective small stack 25 protrudes slightly beyond the rear edge 64 of the front table part 9. Before the guide plate 62 which swings in when the gap 61 opens is placed against the rear edge 64 of the front table part 9, it is therefore necessary for the guide plate 31, which is positioned corresponding to the parallelogram shape, to be moved back corresponding to this overhang, as shown by the arrow in FIG. 12, by operating the electric servomotor 34 in this direction via the machine electronics, so that the guide plate 31 is moved forwards correspondingly, simultaneously with the excess displacement of the respective small stack 25, as illustrated in FIG. 13. The small stacks 25 are subsequently aligned in the shape of a right parallelepiped shape, as illustrated in FIG. 14, whereupon the guide plate 31 is swiveled back into its position perpendicular to the table surface 10 by operating the pneumatic cylinder 47 and the bearing element 33 is simultaneously moved slightly towards the second guide plate 62 by means of the electric servomotor 34, in order to compensate for the difference in distance which is due to the mounting of the guide plate on the pivot 39 which is at a distance from the table surface 10. These movements are also executed by defined actuations via the machine electronics. The row of small stacks 25 which is disposed in the transverse channel 68 formed between the two guide plates 31 and 62 is subsequently transported away towards the transverse channel 68 by means of an ejector 67, which in its inoperative position is positioned in the region of the placement table 20. For this purpose, the ejector 67 is lowered behind the row of small stacks 25 and is moved towards the other placement table 21. For example, FIG. 1 shows a row 24 of small stacks such as this which was the last to be transported away, although this is shown there for the initial stack which was cut in the preceding operation. These small stacks 25 are punched or bundled in the further processing station 23.

After ejecting the row of small stacks 25, the ejector 67 is moved into its initial position shown in FIG. 4, the guide plate 62 is swung back, and by moving the front table part 9 the gap 61 between the latter and the rear table part 5 is closed again. This is followed by the advance of the material to be cut by the predetermined cut distance, in the direction illustrated in FIG. 15, whereupon the electric servomotor 34 is activated in the direction of the arrow illustrated, in order to align the complete stack, which is formed from the individual longitudinally aligned stacks, against the feed cradle 15 by means of the vertically aligned guide plate 31. This is followed by the sequence of cuts shown in the illustrations of FIGS. 11 to 14. After the last cut, and after transporting away the small stack 25 which is thereby produced, the guillotine cutter machine is moved into the position shown in FIG. 15 and the row of small stacks 25 which remains on the rear table part 5 after the last cut is transferred as far as possible by the feed cradle 15 on to the front table part 9. After opening the gap 61, the guide plate 62 is then moved towards the rear edge 64 of the front table part 9 and thereby moves this last row completely on to the front table part against the guide plate 31. This row is then also fed to the further processing station 23 by means of the ejector 67.

When all the rows of small stacks 25 have been fed to the further processing station 23, the reduced pressure acting on the suction elements 53 is disconnected and the mobile alignment station 22 is moved to the placement table 21 again, so that the next initial stack, after its edges have optionally been trimmed, can be manipulated on the front table part 9 which has now become free.

FIGS. 1 to 4 show that a central connection 69 leads to the mobile alignment station 22. This connection comprises the pneumatic lines to the pneumatic cylinder or cylinders 47 or 57 to 59, respectively, and further comprises reduced pressure connections for the suction elements 53 and the electrical connections to the servomotor 34. The central connection 69 is coupled to the electronics unit which controls the units (pneumatic cylinders, servomotor, suction elements) of the mobile alignment station 22 and which can also comprise a distance recording system for determining the relative position of the mobile alignment station 22, i.e. perpendicular to the cutting plane. It is thereby possible, irrespective of the reference position of the feed cradle 15 and of the stack of material to be cut which is seated against the latter, to align the mobile alignment station 22 with respect to the cutting plane. This can be effected with respect to any desired location of the front table part 9. In particular, the advance movement data of the feed cradle 15 can be taken into account by means of the electronics, whereby the electric servomotor 34 can be operated depending on different extents of advance. In contrast, if a plurality of pneumatic cylinders 57, 58 and 59 is used instead of the electric servomotor 34, only a few extents of advance of the guide plate 31 can be produced, and one of the cylinders is employed for compensation when the guide plate 31 swivels.

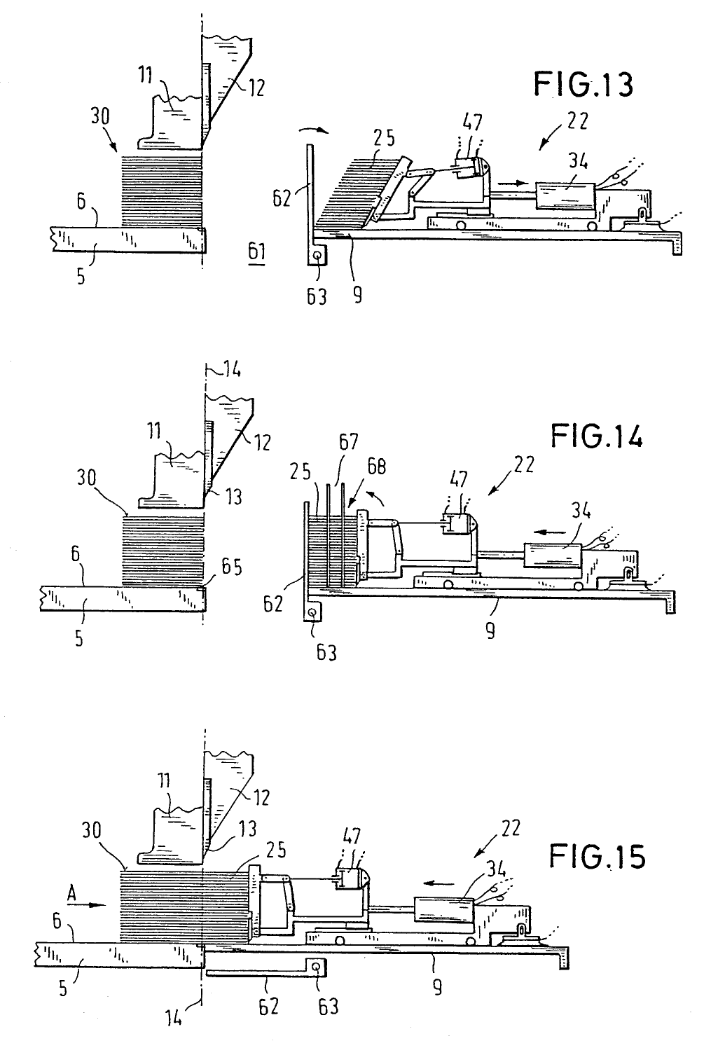

One extent of advance of the electric servomotor 34, which is operated via the electronics, or of the pneumatic cylinders 57 to 59, which are also operated electronically, is thus employed for compensation when the guide plate 31 swivels, and a second extent of advance is employed for adapting to the variable width of the material to be cut corresponding to the advance of the feed cradle. A third extent of advance should be considered to be associated with an intermediate cut which is inserted between two main cutting operations for the production of the row of small stacks 25. Reference is made to EP-A-0 056 874 with regard to the problems associated with intermediate cuts. A cutting operation taking into account an intermediate cut in which a thin strip of waste 70 is produced is illustrated in FIGS. 16 to 19. The conditions in FIG. 16 correspond to those in FIG. 11. After the cut, with the simultaneous swiveling of the guide plate 31 and the movement of the bearing element 33 slightly away from the cutting knife, an intermediate advance of the material to be cut is effected via the feed cradle 15, as shown in FIG. 17. It is necessary to move the bearing element 33 away from the cutting plane 14 by this extent by operating the electric servomotor 34. The small stacks 25 are then displaced into the shape of a right parallelepiped, as shown in the illustration of FIG. 18, by swiveling the guide plate 31 back, in the sense of the illustration of FIG. 14, into the position in which it is oriented perpendicularly to the table surface 10, with the pneumatic cylinder 47 and the electric servomotor 34 being operated. In order to form the gap 61, the front table part 9 is then moved away from the rear table part 5 and the guide plate 62 is swiveled towards the rear edge 64 of the front table part 9. The row of small stacks 25 is fed to the further processing station by means of the ejector 67 and at the same time the intermediate cut is made, during which the resulting strips of waste material 70 are disposed of downwards through the gap. This results in the situation shown in FIG. 14. The gap is subsequently closed again in the sense of the illustration of FIG. 15.

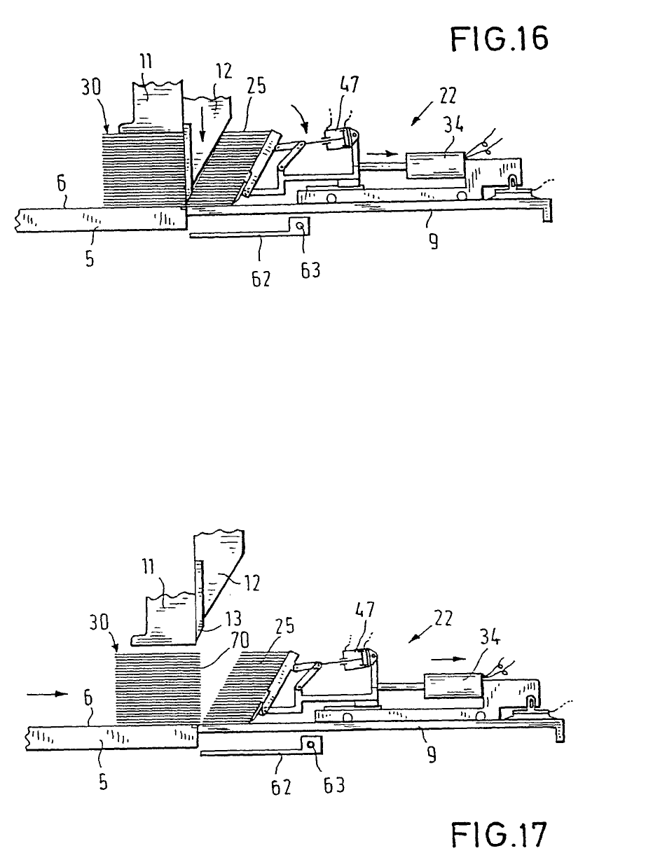

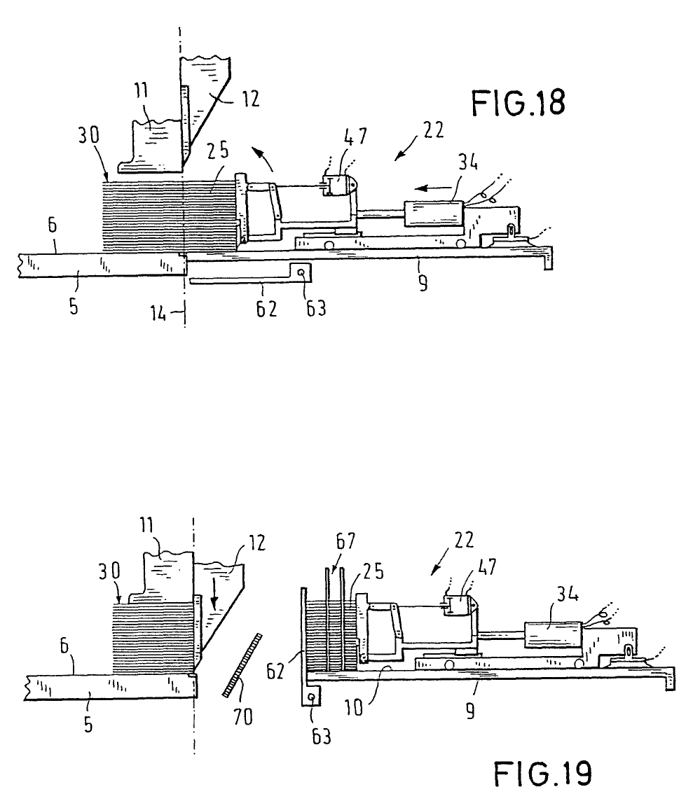

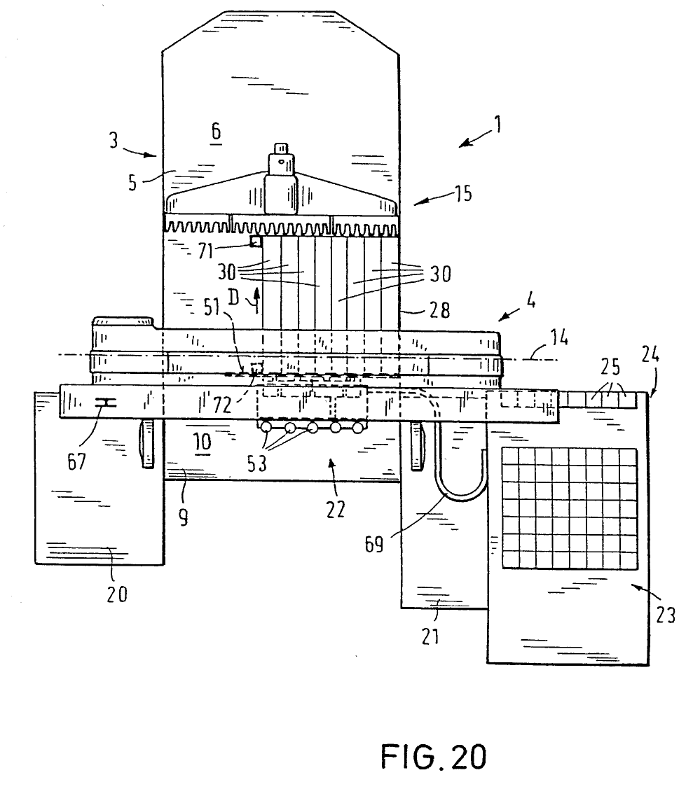

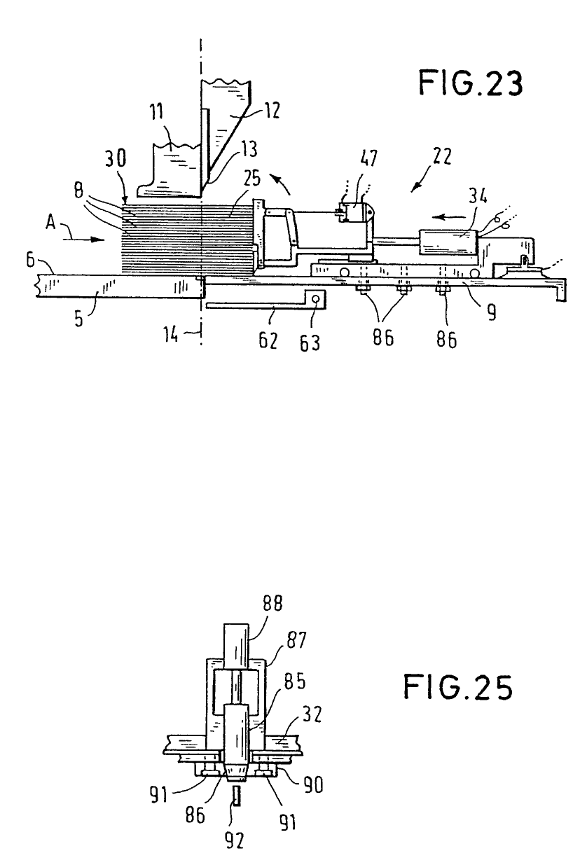

The embodiment of the guillotine cutter machine 1 shown in FIG. 20 comprises a lateral contact placement device 71 fixed to the feed cradle 15 and a lateral contact placement device 72 fixed to the first guide plate 31 for placing the partial stack 30 against the fixed lateral contact placement device 28 of the rear table part 5. The construction and mode of operation of the lateral contact placement device 71 on the feed cradle 15 are illustrated in greater detail in FIGS. 21 and 22, and the construction and mode of operation of the lateral contact placement device 72 on the first guide plate 31 are illustrated in greater detail in FIG. 24. FIGS. 21 and 22 show a contact placement guide plate 73 with a guide shaft 74 in a parked position. A contact placement device guide 75, on which a receiver 76 can slide, is provided for size adjustment. The contact placement guide device receives a swiveling receiver 77 in which a swiveling cylinder 78 is mounted. The latter is employed for swiveling the contact placement guide plate 73 by 90° from its horizontal parked position shown in FIG. 21 into its vertical operating position which is also shown in this Figure. The contact placement guide plate 73 can be moved, by means of a displacement cylinder 79 mounted in the receiver 76, into the operating region in front of the feed cradle 15 and back, so that the contact placement guide plate 76 is placed outside the region of action of the grid 16 of the feed cradle 15. This is necessary when the feeder device is advanced to its maximum extent and the grid 16 of the feeder device 15 meshes and cooperates with the section of the press crosshead 11 which is of correspondingly grid-like construction and accordingly the contact placement device 71 has to be situated outside this region of action of the feed cradle 15 and the press crosshead 11. The lateral contact placement device 72 of the first guide plate 31 comprises a guide shaft 80 for size adjustment, which is disposed parallel to the pivots 39 and is mounted in the actual guide plate body 51. A housing 81, which receives a contact placement cylinder 82, is mounted on the guide shaft. A contact placement guide plate 83, which is parallel to the actual guide plate body 5 1, is mounted in the contact placement cylinder. The manner of adjusting the housing 1 on the guide shaft 80 is not illustrated in the Figure, but can be effected via any desired means, for example by means of an electric servomotor or mechanically. The lateral contact placement devices 71 and 72 are controlled via the machine electronics. The contact placement device 72 is situated in that region of the guide plate 31 or of the mobile alignment station 22 which faces away from the further processing station 23. The length of the guide plate 31 of the mobile alignment station 22 is of course designed so that the contact placement device 72 is situated outside the region which is taken up by the small partial stacks 25.

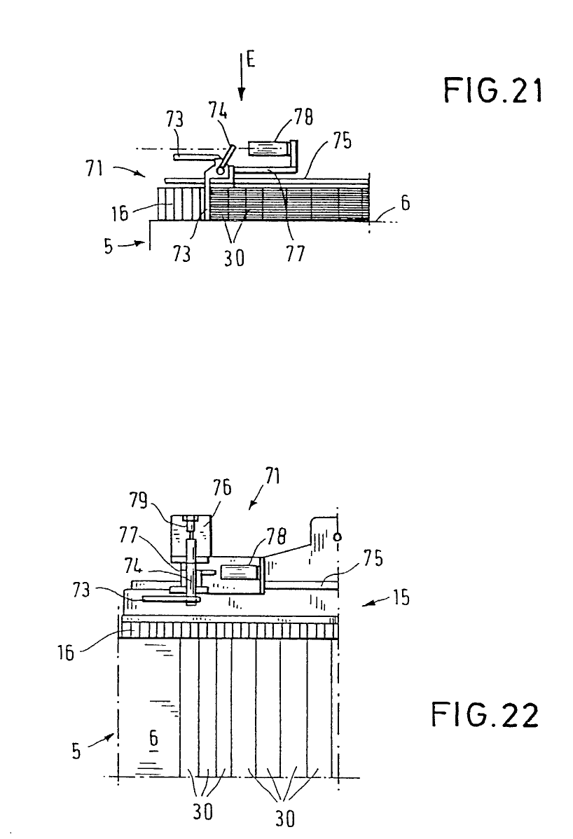

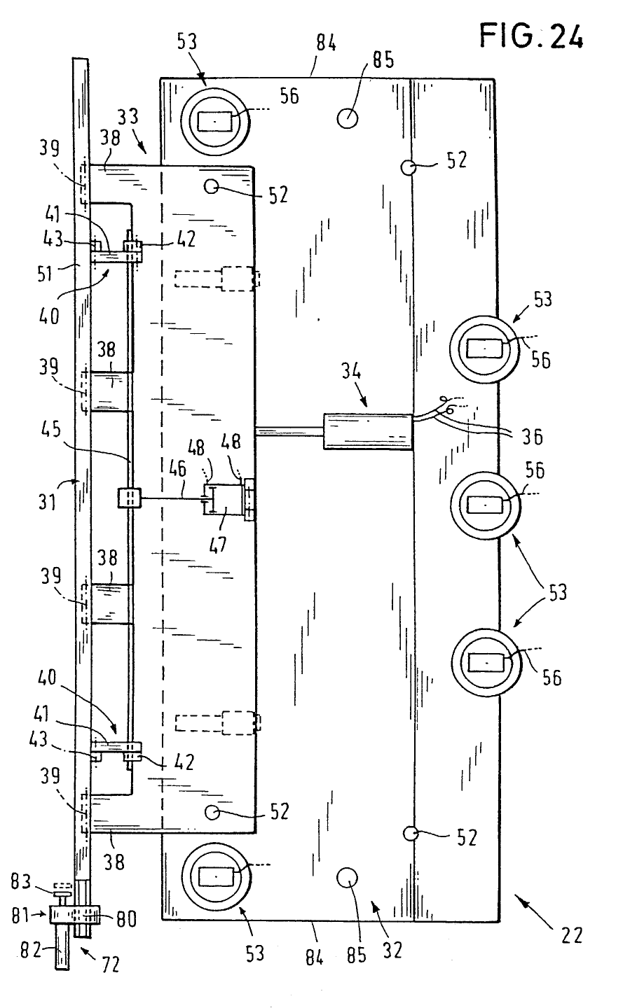

FIGS. 23 to 25 illustrate the form of the device for centering, the mobile alignment station 22 with respect to the front table part 9. As can be seen in the illustration of FIG. 24, the mobile alignment station 22, or specifically the plate-shaped base element 32 thereof, is provided for centering with two centering pins 85 which are disposed in the region of the end faces 84 of the base element 32 and which can be brought into active communication with centering receivers embedded in the front table part 9. The centering pins 85 are disposed in a plane which is positioned parallel to the cutting plane 14 of the cutter 13. As shown in the illustration of FIG. 23, centering receivers 86 are provided in pairs in the front table part 9 at different spacings, in this instance at three different spacings, from the cutting plane 14, so that the plate-shaped base element 32 can be positioned at three different spacings from the cutting plane 14. The positioning spacings are identical, namely the first positioning plane is at the same distance with respect to the associated centering receivers 86 from the second centering plane as is the third centering plane from the second centering plane. FIG. 25 illustrates the construction of the centering device which is associated with the respective centering pin 85. A housing 87 is mounted in the plate-shaped base element 32, and receives a pneumatic cylinder 88 by means of which the centering pin 85 can be moved vertically towards the table surface 10 of the front table part 9 with the mobile alignment station 22 resting thereon. The lower end of the centering pin 85 is of tapered construction and passes through the correspondingly tapered centering receiver 86 in a centering plate 90 which is embedded in the front table part 9 and is attached thereto by means of various fixing elements 91. The centering plate can be adjusted towards the cutting plane 14 via adjustable bushes associated with the fixing elements 91, so that absolute parallelism is ensured between the cutting plane 14 and the guide plate 31 when the latter is in its vertical position. When the centering pin 85 is inserted in the centering receiver 86, contact is made with a limit switch 92 associated with the centering receiver 86, by means of which the precise positioning of the mobile alignment station 22 on the front table part 9 can be monitored. In order to change the position of the alignment station 22, it is merely necessary to raise the two centering pins 85 thereof into their disengaged position and to bring the base element 32 into a new position in which the centering pins 85 are aligned with the associated centering receivers 86, and to lower the centering pins 85 into the centering receivers again. The actual positions of the first guide plate 31 which are necessary during the operation of the guillotine cutter machine can be set via these predetermined, defined positions of the plate-shaped base element 32 of the mobile alignment station 22 in relation to the front table part 9 and via the positions, which are also known, of the adjusting elements for the first guide plate 31. The pneumatic cylinders 88 and the limit switches 92 are operated via the machine electronics.

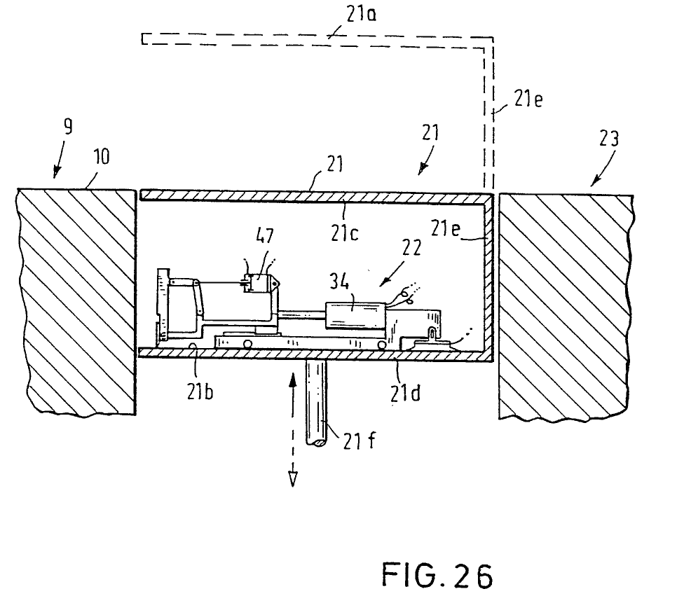

FIG. 26 shows a modified design of the right-hand placement table 21. This comprises two table planes 21a and 21b disposed in parallel one above the other, the table parts 21c and 21d which are associated with these two table planes being joined by means of a stay 21f. A lifting rod 21e, with which the placement table 21 as a whole can be raised and lowered, is attached to the underside of table part 21d. In the lowered position which is shown by the unbroken lines in FIG. 26, the surface of the upper table part 21c forms a plane with the surface of the front table part 9. In the raised position of table part 21c, however, the surface 21b of the lower table part 21d forms a plane with the surface 10 of the front table part 10. The surface 21b serves to receive the mobile alignment station 22 when the latter is not required.

The invention claimed is as follows:

1. A guillotine cutter machine for cutting stacked sheet material, comprising:
a table for receiving the material, said table including a rear table part that receives the material to be cut and a front table part that receives the cut material, wherein the front and rear table parts can be moved apart to form a gap therebetween;
a feeder device;
a press crosshead for the material to be cut;
a cutter for cutting the material;
a first movable guide plate positionable in the region of the front table part;
a second movable guide plate which can be brought into its operating position after the gap has opened to form a transverse channel between the first and second guide plates;
a transport device which can move along the transverse channel; and
an alignment station horizontally repositionable with respect to the front table part and detachably affixed to said front table part via at least one affixing member and including said first guide plate.

2. A guillotine cutter machine according to claim 1, wherein:
the front table part receives the mobile alignment station that is attachable to the front table part.

3. A guillotine cutter machine according to claim 1, including:
a side table part disposed beside said front table part and receiving the mobile alignment station when the mobile alignment station is not in use.

4. A guillotine cutter machine according to claim 3, wherein:
the front and side table parts have surfaces forming a plane; and
the mobile alignment station is movable between the front and rear table parts.

5. A guillotine cutter machine according to claim 3, wherein:
the side table part can be raised and lowered, and includes upper and lower table parts disposed one above the other, wherein the lower table plane receives the mobile alignment station when the mobile alignment station is not in use, and wherein the upper table plane forms a plane with a surface of the front table part when the table part is lowered, and the lower table plane forming a plane with a surface of said front table part when the side table part is raised.

6. A guillotine cutter machine according to claim 1, wherein:
the mobile alignment station has an underside with rollers for movement.

7. A guillotine cutter machine according to claim 1, wherein:
the mobile alignment station includes elements which act by means of reduced pressure and which can be brought into active communication with a lateral stop disposed in the region of the front table part.

8. A guillotine cutter machine according to claim 6, wherein:
the mobile alignment station can be positively attached to a lateral stop disposed in the region of the front table part.

9. A guillotine cutter machine according to claim 8, wherein:
the mobile alignment station includes positioning elements which can be brought into active communication with complementary positioning elements of the front table part.

10. A guillotine cutter machine according to claim 9, wherein:
the positioning elements of the mobile alignment station are centering pins and the complementary positioning elements of the front table part are centering receivers shaped to receive the centering pins.

11. A guillotine cutter machine according to claim 9, wherein:
a plurality of pairs of complementary positioning elements is disposed in the front table part at different vertical spacing from the cutting plane of the cutting knife.

12. A guillotine cutter machine according to any one of claim 1, wherein:
a selected one of the feeder device and the first guide plate includes movable lateral contact placement devices.

13. A guillotine cutter machine according to claim 12, wherein:
the lateral contact placement device of the feeder device can move in the direction of feed and in the opposite direction.

14. A guillotine cutter machine according to claim 1, wherein:
the mobile alignment station includes units that movably receive the first guide plate.

15. A guillotine cutter machine according to claim 1, wherein:
the first guide plate is pivotable above a horizontal pivot.

16. A guillotine cutter machine according to claim 1, wherein:
the mobile alignment station includes a base element in the form of a sheet in which the first guide plate is mounted so that the first guide plate can move and pivot.

17. A guillotine cutter machine according to claim 16, including:
a bearing element;
at least one actuating element mounted in the base element for moving the bearing element;
at least one further actuating element; and wherein
the first guide plate can be pivoted by the at least one further actuating element, the first guide plate being mounted in the bearing element.

18. A guillotine cutter machine according to claim 17, including:
a toggle lever; and wherein:
the guide plate includes a lower end and a bearing element side, the guide plate pivotable in the region of the lower end about a pivot on the bearing element side, and the upper end of the guide plate is mounted in the bearing element via the toggle lever, wherein the further actuating element acts on the toggle lever and on the bearing element.

19. A guillotine cutter machine according to claim 1, wherein:
the actuating elements that move the first guide plate are electric servomotors.

20. A guillotine cutter machine according to claim 1, including:
an electronic controller for operating the actuating elements for the first guide plate and for operating the elements for the attachment of the mobile alignment station to the front table part.

21. A guillotine cutter machine according to claim 20, wherein:
the electronic controller includes a wire-free infrared-based control device.

22. A guillotine cutter machine according to claim 1, wherein:
the mobile alignment station includes elements which act magnetically and which can be brought into active communication with a lateral stop disposed in the region of the front table part.

23. A guillotine cutter machine according to claim 1, wherein:
the actuating elements that move the first guide plate are pneumatic cylinders.
